(19) United States
(12) Patent Application Publication
(10) Pub. No.: US 2006/0214853 A1
(43) Pub. Date: Sep. 28, 2006

(54) Gate antenna

(75) Inventor: Fusao Hori, Izu (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Toshiba Tec Kabushiki Kaisha, Shinagawa-ku (JP)

(21) Appl. No.: 11/365,561

(22) Filed: Mar. 1, 2006

(30) Foreign Application Priority Data
Mar. 28, 2005 (JP) 2005-091398

(51) Int. Cl. H01Q 1/38

(52) U.S. Cl. 343/700 MS

(57) ABSTRACT

A first power feed section is disposed in a specified position in the plane of a substantially rectangular planar antenna conductor so as to generate linearly-polarized waves that resonate in a specified direction in the plane of the planar antenna conductor. A second power feed section is disposed in a specified position in the plane of the planar antenna conductor so as to generate linearly-polarized waves that resonate in the direction substantially perpendicular to the specified direction. The first and second power feed sections are alternately supplied with high-frequency power from a high-frequency switching circuit.

### CROSS-REFERENCE TO RELATED APPLICATION

This application is based upon and claims the benefit of priority from prior Japanese Patent Application No. 2005-091398, filed on Mar. 28, 2005, the entire contents of which are incorporated herein by reference.

### BACKGROUND OF THE INVENTION

1. Field of the Invention

The present invention relates to gate antennas for use in wireless tag systems, and in particular, it relates to a gate antenna using a patch antenna.

2. Description of the Background

Attention is being given to wireless tag systems of 2.45 GHz band. In wireless tag systems using antennas for linearly-polarized wave, the rate of reading varies with the direction of antennas built in wireless tags. When the direction of wireless tag antennas is agreed with the direction of the amplitudes of the electric fields, the antennas of wireless tags can easily receive radio waves and so the reading rates become the maximum. The reading rates depend on the angles of antennas in such a manner that they decrease as the antennas of wireless tags are rotated clockwise, and become nearly zero at an angle of 90 degrees. The angle dependency is shown in FIG. 1A. To evade the angle dependency of wireless tags, circularly-polarized wave antennas can be used. With the circularly-polarized-wave antenna as shown in FIG. B, the polarization plane spins through 360 degrees, so that wireless tags can detect the radio wave at any angles. However, the circularly-polarized-wave antennas have the disadvantage of short communication ranges about one half of those of linearly-polarized-wave antennas with the same output. Moreover, since the available maximum output of antennas is prescribed by the Radio Law, the output cannot exceed that prescribed.

### SUMMARY OF THE INVENTION

The invention has been made in consideration of the above-described problems. Accordingly, an advantage of the present invention is to provide a gate antenna in which the angle dependency of the wireless tags of linearly-polarized-wave antennas is reduced and which has substantially the same communication range as that of linearly-polarized-wave antennas.

To achieve the above advantage, one aspect of the present invention is to provide a gate antenna including: a substantially rectangular planar antenna conductor; a first power feed section disposed in a specified position in the plane of the planar antenna conductor so as to generate linearly-polarized waves that resonate in a specified direction in the plane of the planar antenna conductor; a second power feed section disposed in a specified position in the plane of the planar antenna conductor so as to generate linearly-polarized waves that resonate in the direction substantially perpendicular to the specified direction; first and second feeder lines connected to the first and second power feed sections, respectively; and a high-frequency switching circuit connected to the first and second feeder lines so as to supply the high-frequency power alternately.

With the gate antenna according to an embodiment of the invention, two orthogonal linearly-polarized waves can be switched and output alternately. Accordingly, the directivity of wireless tags using a linearly-polarized-wave antenna can be decreased. Furthermore, the gate antenna according to the embodiment can be used with electric fields stronger than those by the circularly-polarized-wave antennas, and the angle dependency of wireless tags can be decreased, thus providing stable recognition.

### BRIEF DESCRIPTION OF THE DRAWINGS

FIG. 1A is a diagram showing the reading relationship between the output radio wave and the wireless tag of a conventional linearly-polarized-wave antenna;

FIG. 1B is a diagram showing the reading relationship between the output radio wave and the wireless tag of a conventional circularly-polarized-wave antenna;

FIG. 2A is a plain view of the essential part of a gate antenna according to an embodiment of the invention;

FIG. 2B is a cross-sectional view thereof;

FIG. 3 is a block diagram showing a configuration of the gate antenna including a drive circuit according to an embodiment of the invention;

FIG. 4A is a diagram showing a state in which a second feed point is driven in the gate antenna according to an embodiment of the invention; and

FIG. 4B is a diagram showing a state in which a first feed point is driven in the gate antenna according to an embodiment of the invention.

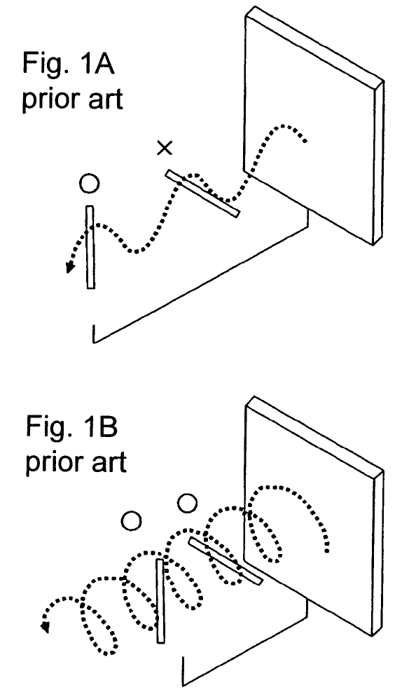

### DETAILED DESCRIPTION OF THE INVENTION

An embodiment of the invention will be described hereinbelow with reference to the drawings.

Linearly-polarized-wave patch antennas are generally formed in such a manner that an about half-wavelength square conductor pattern is disposed on a substrate with a layer structure in which a conductor pattern and a ground pattern are opposed with a dielectric therebetween, and a power feed section is provided to resonate radio waves. For example, for 2.45-GHz patch antennas, half wavelength λ/2 can be given by
λ/2=C/2f=3×10⁸/4.9×10⁹=61.2 (mm)
where C is the velocity of light, f is the frequency and λ is the wavelength. The wavelength is that in air. Accordingly, when the dielectric constant of a substrate used is 4.3, the wavelength is decreased by the amount of refraction. Thus, the wavelength is expressed as
61.2/√4.3=29.5 (mm)

The position of the power feed section is set so that the input impedance matches the impedance of the system used, e.g., 50 ohms.

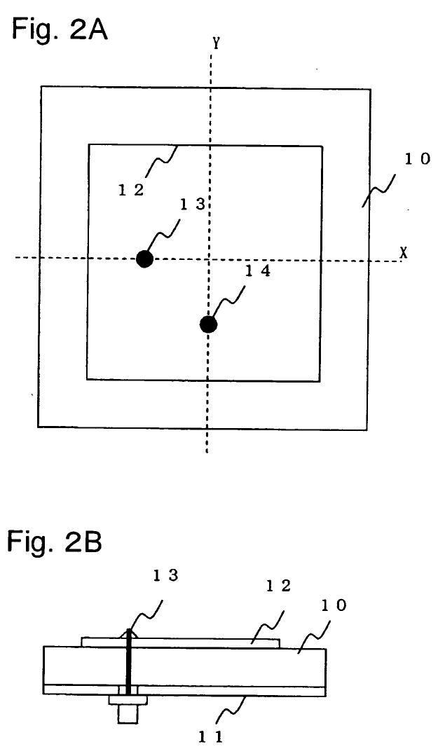

FIGS. 2A is a plan view of a gate antenna using a patch antenna according to an embodiment of the invention; and FIG. 2B is a cross-sectional view taken along X-axis.

A ground conductor 11 is disposed on the back of a dielectric substrate 10. A substantially square planer conductor pattern 12 is disposed on the surface. The side of the conductor pattern 12 has an approximate half wavelength. First and second power feed sections 13 and 14 are disposed in a specified position on the conductor pattern 12. The first power feed section 13 is disposed in the position at which linear polarization resonating with respect to a specified direction, e.g., in the direction of X-axis in the plane of the conductor pattern 12, as shown in FIG. 2A occurs. The second power feed section 14 is disposed in the position at which linear polarization resonating with respect to the direction substantially perpendicular to the specified direction, e.g., in the direction of Y-axis, as shown in FIG. 2A occurs. The positions of the first and second power feed sections 13 and 14 are set so that the input impedances match the impedance system of a system used. The power feed sections 13 and 14 are disposed at a substantially equal distance from the intersection of the X-axis and Y-axis, that is the center of the patch antenna, in FIG. 2.

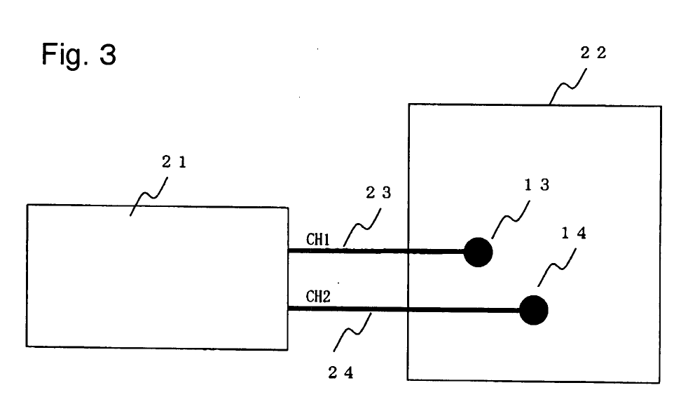

As shown in FIG. 3, the first and second power feed sections 13 and 14 connect to first and second feeder lines 23 and 24, respectively, through which high-frequency power is supplied alternately. The first and second feeder lines 23 and 24 are each, e.g., formed of a coaxial cable. High-frequency power is supplied from a separate high-frequency power circuit (not shown). The high-frequency power is switched by a high-frequency switching circuit 21, and is fed through the first and second feeder lines 23 and 24 alternately. The high-frequency switching circuit 21 may be a single port double throw (SPDT) switch that distributes one input to two output ports. The electrical switch may be disposed either inside or outside the antenna.

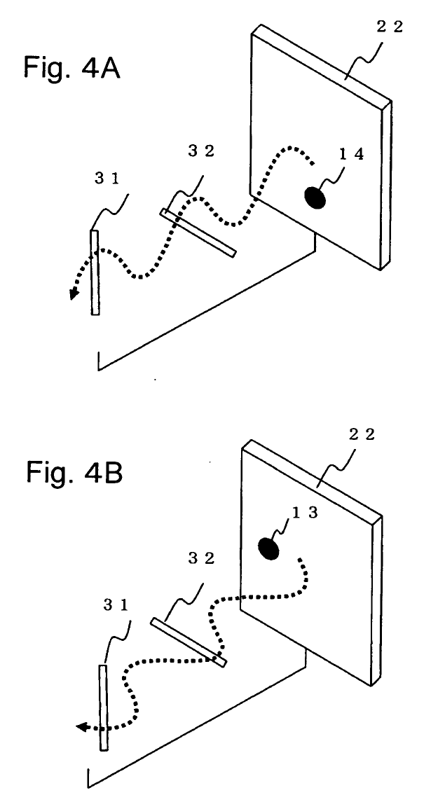

The action of the gate antenna according to an embodiment of the invention will be described with reference to FIGS. 4A and 4B.

Referring to FIGS. 4A and 4B, the long sides of wireless tags 31 and 32 agree with the directions of the antennas in the wireless tags, respectively. When a channel CH1 of the two output ports of the high-frequency switching circuit 21 is turned off, and a channel C2 is turned on, the second power feed section 14 is fed with power via the second feeder line 24 to generate a vertical polarized wave, as shown in FIG. 4A. Since the reception of the radio wave depends on the direction of the antenna, the wireless tag 31 can be read, but the wireless tag 32 cannot be read. However, in the next time slot, the channel CH1 is turned on and the channel CH2 is turned off, so that the first power feed section 13 is fed with power via the first feeder line 23 to generate a horizontal polarized wave. As a result, the wireless tag 31 cannot be read, but the wireless tag 32 can be read. Thus, either of a vertical polarized wave and a horizontal polarized wave can be received in one cycle of channel switching, and thus wireless tags can be read in either of the vertical direction and the horizontal direction.

In this case, the range of communication is the shortest for a wireless tag with an angle of 45 degrees. However, there is no angle at which the wireless tag cannot be read at all unlike the linearly-polarized-wave antennas. Moreover, the power for the gate antenna to obtain the same field strength is the same as that of the linearly-polarized-wave antennas, i.e., one half of that of a circularly-polarized-wave antenna.

With the antenna 22 having the above structure, when the first power feed section 13 and the second power feed section 14 are continuously fed with power with a 90-degree phase difference of electric field, circularly-polarized waves can be generated. According to an embodiment of the invention, alternate feeding to the first power feed section 13 and the second power feed section 14 allows the patch antenna to output orthogonal linearly-polarized waves alternately.

Since circularly-polarized-wave antennas output orthogonal linearly-polarized waves at the same time, they have the advantage that the reception of radio waves does not depend on the angle of wireless tags. However, vertical output is wasted in the case where wireless tags are arranged in the same direction. Accordingly, with the same output, the maximum communication range of circularly-polarized-wave antennas becomes about one half of that of linearly-polarized-wave antennas.

According to an embodiment of the invention, two orthogonal linearly-polarized waves are switched with time and radiated alternately, thus increasing the strength of the electric field by using the combined outputs, unlike the circularly-polarized type in which two orthogonal linearly-polarized waves are output at a phase difference of 90 degrees and double power is required. Furthermore, since orthogonal polarized waves are output alternately, wireless tags in either polarized direction can be read.

With the patch antenna and a wireless tag reader according to an embodiment of the invention, two orthogonal linearly-polarized waves can be switched and output alternately. Accordingly, the directivity of wireless tags is decreased and the range of reception is increased. Furthermore, since two orthogonal linearly-polarized waves are switched with time and radiated alternately, an embodiment of the gate antenna radiates with electric fields are stronger than those by the circularly-polarized-wave antennas.

Thus, the reading range of wireless tags equal to that of linearly-polarized-wave antennas can be provided, and the angle dependency of wireless tags can be decreased, thus providing stable recognition.

It is to be understood that the invention is not limited to the foregoing embodiment, but may be embodied without departing from the spirit and scope of the invention.

What is claimed is:

1. A gate antenna comprising:
a substantially rectangular planar antenna conductor;
a first power feed section disposed in a specified position in the plane of the planar antenna conductor so as to generate linearly-polarized waves that resonate in a specified direction in the plane of the planar antenna conductor;
a second power feed section disposed in a specified position in the plane of the planar antenna conductor so as to generate linearly-polarized waves that resonate in the direction substantially perpendicular to the specified direction;
first and second feeder lines connected to the first and second power feed sections, respectively, so as to supply high-frequency power alternately; and
a high-frequency switching circuit connected to the first and second feeder lines so as to supply the high-frequency power alternately.

2. The gate antenna according to claim 1, wherein the first and second power feed sections are disposed on the same circumference with substantially the center of the planar antenna conductor as the center.
